(19) United States
(12) Patent Application Publication
(10) Pub. No.: US 2026/0266629 A1
(43) Pub. Date: Sep. 10, 2026

(54) METHOD AND APPARATUS FOR ENVIRONMENTAL BARRIER TO REDUCE FALSE ALERTS

(71) Applicant: Ecolab USA Inc., Saint Paul, MN (US)

(72) Inventors: Daniel Ronald Schwartz, Cottage Grove, MN (US); Chelsea Petti Breiling, Minneapolis, MN (US); Jason Scott Piehl, Bloomington, MN (US); Matthew James Hobbs, St. Paul, MN (US)

(21) Appl. No.: 19/558,673

(22) Filed: Mar. 6, 2026

Related U.S. Application Data
(60) Provisional application No. 63/768,268, filed on Mar. 7, 2025.

(51) Int. Cl. G01D 5/24; G01D 18/00

(52) U.S. Cl. CPC G01D 5/2405; G01D 18/00

(57) ABSTRACT

Various examples are directed to apparatus and methods for an environmental barrier to reduce false alerts for pest detection devices. A pest detection device is disclosed, including a housing with a front surface that includes multiple drainage openings and defines an internal chamber. Within this chamber, a capacitive sensor is positioned to detect the presence of pests near the drainage openings. An environmental barrier is affixed to the front surface of the housing, selectively covering peripheral portions of the drainage openings. This design prevents water spray from entering the internal chamber while allowing water to drain through, thereby reducing false alerts caused by transient changes in sensor capacitance.

### CLAIM OF PRIORITY AND INCORPORATION BY REFERENCE

The present application claims the benefit under 35 U.S.C. §119(e) of U.S. Provisional Patent Application 63/768,268, filed March 7, 2025, the disclosure of which is hereby incorporated by reference herein in its entirety.

### TECHNICAL FIELD

The present disclosure pertains to methods and apparatus for pest detection devices, and more particularly to methods and apparatus for an environmental barrier to reduce false alerts for pest detection devices for improved sensing and operation.

### BACKGROUND

A number of devices are used to detect pests. One such device is an electronic sensor that detects the presence of a pest by measuring a change in capacitance due to a pest’s presence on or near a capacitive sensor. Other sensors may be used instead of or in conjunction with capacitive sensors.

Capacitive sensing can be used to detect, among other things, the presence of an object or body within relation to the sensor itself. Capacitive sensors for pest detection may be able to detect not only rodents and adult insects but also the nymphs, which are extremely small in comparison. In order for changes in the environment to not cause errors in the capacitive sensing accuracy for pest detection, the capacitive sensor should be able to function within acceptable tolerances in changing environmental conditions.

There is a need in the art for an improved pest detection device that will resist moisture and particle ingress and better detect pests.

### SUMMARY

A pest detection device is provided, including a housing with a surface that includes a plurality of drainage openings and at least partially defines an internal chamber. Within this chamber, a capacitive sensor is disposed and is configured to detect the presence of one or more pests. An environmental barrier is affixed to the surface of the housing, designed to selectively cover portions of the drainage openings. This configuration prevents water spray from entering the internal chamber while allowing water to drain through, thereby sensing errors caused by transient changes in sensor capacitance.

Additionally, a method for making a pest detection device with an environmental barrier to reduce false alerts is described. The method involves providing a housing with a surface having a plurality of drainage openings and defining an internal chamber. A capacitive sensor is installed within this chamber, configured to detect pests near the drainage openings. An environmental barrier is affixed to the surface of the housing, selectively covering portions of the drainage openings to prevent water spray from entering the chamber while allowing drainage, thus reducing false alerts due to capacitance changes.

Furthermore, a pest detection system is disclosed, including a housing with a surface that includes drainage openings and defines an internal chamber. A capacitive sensor is placed within this chamber to detect pests near the drainage openings. An environmental barrier is affixed to the housing, selectively covering portions of the drainage openings to prevent water spray from entering the chamber while permitting drainage. The system reduces sensing errors from capacitance changes. In various embodiments, the system includes a controller configured to process signals received by the capacitive sensor and to communicate pest detection data to an external device.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1A is an illustration of a front view of a pest detection and containment device, according to various embodiments.

FIG. 1B is an illustration of a side view of a pest detection and containment device, according to various embodiments.

FIG. 1C is an illustration of a bottom view of a pest detection and containment device, according to various embodiments.

FIG. 1D is an illustration of a top down cross-section of a pest containment device, according to various embodiments.

FIG. 2 illustrates an example embodiment of a method for making a pest detection device with an environmental barrier to reduce false alerts, according to various embodiments.

FIG. 3A is an illustration of a bottom view of a pest detection and containment device with a snap-in plastic environmental barrier, according to various embodiments.

FIG. 3B is an illustration of a rear view of a snap-on environmental barrier, according to various embodiments.

FIG. 3C is an illustration of a front view of a snap-on environmental barrier, according to various embodiments.

FIG. 4A is an illustration of a rear view of a snap-on environmental barrier, according to various embodiments.

FIG. 4B is an illustration of a front view of a snap-on environmental barrier, according to various embodiments.

FIG. 5 is a block diagram of a machine in the example form of a computer system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

Pest detection and/or containment devices with capacitive sensors for small pest detection may have sensitivity to external environmental conditions, such as moisture level and temperature. In pest control and/or monitoring devices a certain amount of drainage is necessary as the device itself must have an opening for the pest to enter and interact with the device. Therefore, a certain amount of moisture ingress is possible with all enclosure designs and a facility to drain moisture from the trap is necessary to prevent accumulation of moisture in the device. Past devices may have produced false alerts of pest presence due to changes in external environmental conditions. The present system provides for, among other things, a pest detection device with an environmental barrier to reduce false alerts to enable pest detection devices to provide robust and accurate detection of even smaller rodents, insects, and other pests.

This application incorporates by reference the entirety of U.S. Patent No. 6,937,156, titled: Method and Apparatus for Capacitively Sensing Pests, which is owned by applicant Ecolab, Inc.

Capacitive sensing systems may experience a baseline capacitive value that is established for a current environment (humidity, temperature). As environmental parameters change, the capacitive baseline value may change and the device may be calibrated, that is, changed to a new expected capacitance value to enhance sensing when an object or body comes within range of the sensor. If the expected capacitance value is not updated, changes in the environment around the pest detection device may result in a higher baseline capacitance value which may result in false senses when the sensed capacitance reaches a threshold value (for example, higher humidity may increase the baseline capacitance) or a lower baseline capacitance (for example, lower humidity may decrease the baseline capacitance) which results in less accurate senses due to the lower baseline capacitance. The present subject matter includes an apparatus and method for providing an environmental barrier to reduce false alerts and to increase the reliability of sensing by pest detection devices.

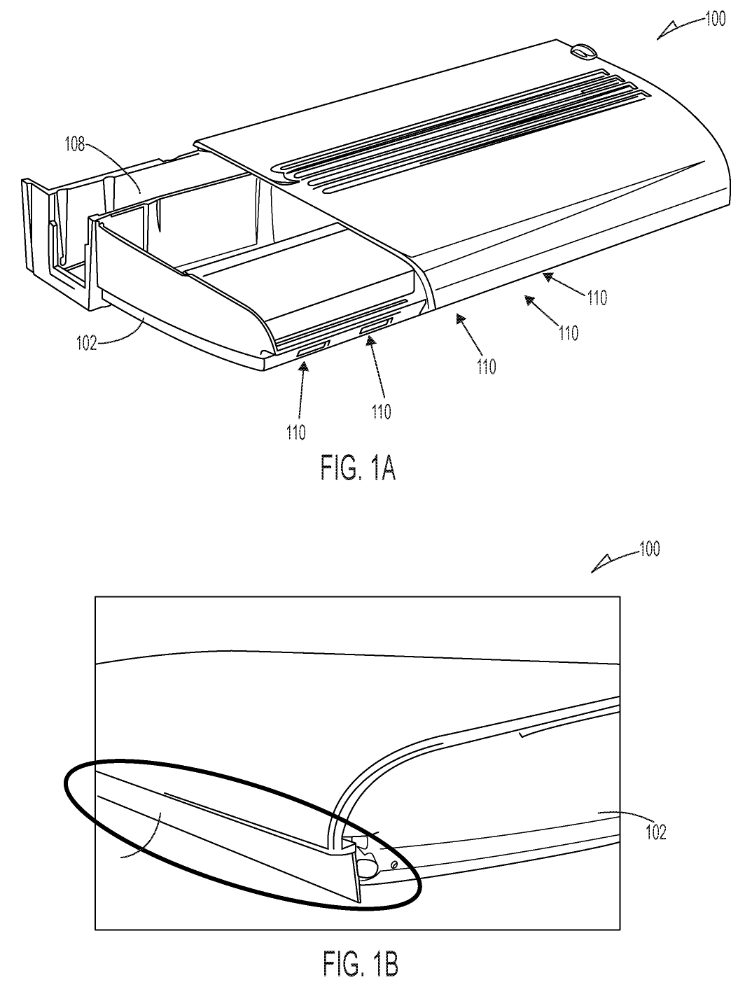

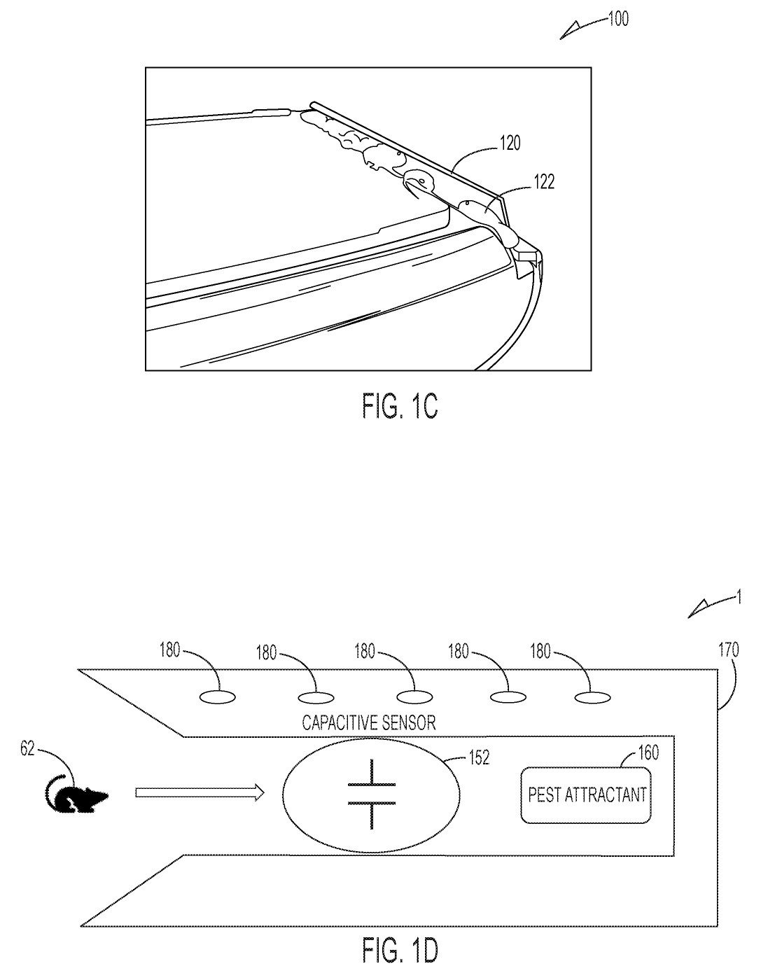

FIG. 1A is a schematic drawing of a pest detection device 100 (or pest monitoring device, or pest containment device such as a trap), according to one embodiment of the present subject matter. The pest detection device 100 includes a capacitive sensor (not shown) configured to detect a presence of one or more pests. The capacitive pest detection of the present subject matter may be used for monitoring, detecting, or trapping insects (such as cockroaches or bedbugs or termites), rodents (such as mice or rats), or other types of pests including, but not limited to, those discussed in this document.

The pest detection device 100 includes a housing 102 with a front surface that includes a plurality of drainage openings 110 and defines an internal chamber 108. Within this internal chamber 108, a capacitive sensor (not shown) is disposed. The capacitive sensor is configured to detect the presence of one or more pests in proximity to the drainage openings. An environmental barrier is affixed to the front surface of the housing, designed to selectively cover peripherally located portions of the drainage openings. This configuration prevents water spray from entering the internal chamber while permitting water to drain therethrough, thereby reducing false alerts resulting from transient changes in sensor capacitance.

According to various examples, the capacitive sensor may be configured as a multi-layer sensor to improve sensitivity to small pests. The sensor may also include a calibration feature to adjust for environmental changes, thereby reducing false alerts. The environmental barrier can be configured as a physical shield to prevent moisture ingress into the housing and may include a drainage system to channel water away from the capacitive sensor. The housing may be constructed or made from a water-resistant material to protect the internal components from environmental conditions. Additionally, the device may include a controller configured to process signals from the capacitive sensor and differentiate between pest types based on detected capacitance changes, and the controller may include a user interface for local configuration and status monitoring. In various embodiments, a controller and capacitive sensor are disposed in the internal chamber 108 of the pest detection device 100.

The controller is configured to detect capacitance changes using the capacitive sensor, and may include one or more of a microprocessor, a microcontroller, a dedicated circuit, logic components, or combinations thereof to perform the detection and other functions for the device, in various embodiments. The device 100 may also include wireless communication capability including, but not limited to, a long and/or short range wireless antenna and associated communication circuitry. A number of wireless protocols may be used by the present device to communicate and report pest detection results or other data to one or more external devices (such as a computer, a smartphone, a tablet, etc.), to other pest detection devices, to a router, to a gateway, or the like. The wireless standards that may be used by the present subject matter include, but are not limited to, one or more of the following: LoRa, LoRaWAN, near-field communication (NFC), Bluetooth, Bluetooth Low Energy (BLE), Ethernet, Wi-Fi, WiMax, Zigbee, or cellular standard communications such as 3G, 4G, 5G and LTE. Other wireless standards may be used without departing from the scope of the present subject matter.

In various embodiments, the capacitive sensor is included in the internal chamber 108 of the detection device 100 and is calibrated soon after powering up the device. In various embodiments, the calibration can be conducted by remote command, based on a sensor, based on a timer, or by other inputs, including but not limited to combinations of two or more of the foregoing. Those of skill in the art will appreciate that other approaches are possible without departing from the scope of the present subject matter.

FIG. 1B illustrates a pest detection device 100, featuring an environmental barrier 120 affixed to the front surface of the housing 102. The housing 102 includes a plurality of drainage openings, and the internal chamber (or internal portion of the housing 102) houses a capacitive sensor configured to detect the presence of one or more pests in proximity to these openings. The environmental barrier 120 is designed to selectively cover peripherally located portions of the drainage openings, effectively preventing water spray from entering the internal chamber while allowing water to drain through. This arrangement reduces false alerts caused by transient changes in sensor capacitance.

FIG. 1C illustrates a portion of a pest detection device 100, focusing on the environmental barrier 120 and the attachment mechanism of the barrier. The pest detection device 100 is designed to detect pests while minimizing false alerts due to environmental factors such as moisture ingress.

The environmental barrier 120 plays an important role in the pest detection device 100, serving to protect the internal chamber 108 from water spray while allowing drainage through the drainage openings 110. The barrier is strategically affixed to the front surface of the housing, covering peripherally located portions of the drainage openings 110. This selective coverage ensures that water is directed away from sensitive internal components, thereby reducing the likelihood of false alerts caused by transient changes in sensor capacitance.

In various embodiments, adhesive 122 is used to secure the environmental barrier 120 to the housing of the pest detection device 100. This adhesive 122 is chosen for its durability and resistance to environmental conditions, ensuring that the barrier remains firmly in place over time. The adhesive 122 plays a significant role in maintaining the integrity of the environmental barrier 120, thereby enhancing the overall reliability and effectiveness of the pest detection device 100 in various environmental conditions.

FIG. 1D is an illustration of a top down cross-section of a pest containment device, according to various embodiments. The depicted embodiment shows a rodent containment device 150, but other types of detection or containment devices may be used without departing from the scope of the present subject matter. The rodent containment device 150 includes a housing 170 and an attractant 160 within the housing to attract rodents 162. The rodent containment device further includes a capacitive sensor 152 within the housing. The capacitive sensor 152 may be used to sense the presence of a rodent, to provide a rough size of the rodent, and/or to identify the rodent based on body type, walking characteristics, or other identifying traits which may be stored in a predetermined profile, for example. The housing also features drainage openings 180, which facilitate the drainage of water, thereby protecting the internal components from moisture ingress.

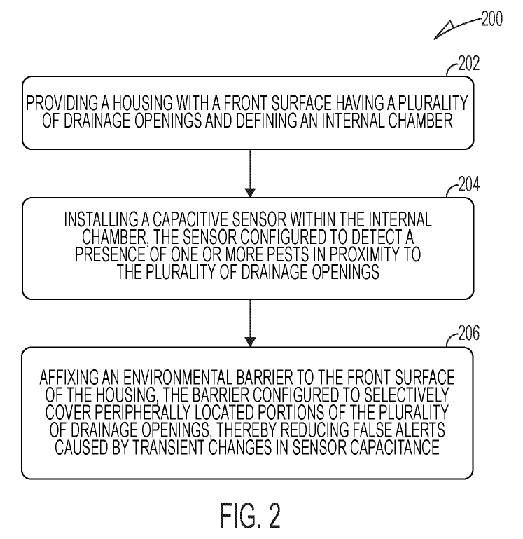

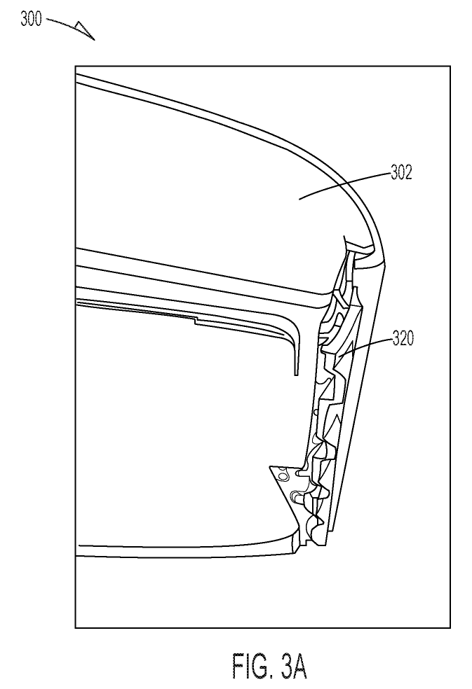

FIG. 2 illustrates an example embodiment of a method for making a pest detection device with an environmental barrier to reduce false alerts. The method 200 includes providing a housing with a front surface having a plurality of drainage openings and defining an internal chamber, as shown at step 202. At step 204, the method involves installing a capacitive sensor within the internal chamber, the sensor configured to detect a presence of one or more pests in proximity to the plurality of drainage openings. Finally, at step 206, the method includes affixing an environmental barrier to the front surface of the housing, the barrier configured to selectively cover peripherally located portions of the plurality of drainage openings, thereby reducing false alerts caused by transient changes in sensor capacitance.

In some examples, the method may further include configuring the capacitive sensor as a multi-layer sensor to enhance sensitivity to small pests. Additionally, the method may involve incorporating a calibration feature into the capacitive sensor to adjust for environmental changes, thereby reducing false alerts. Affixing the environmental barrier may include integrating a drainage system to channel water away from the capacitive sensor. The method may also involve constructing the housing from a water-resistant material to protect the internal components from environmental conditions. Furthermore, the method may include configuring a controller to process signals from the capacitive sensor and differentiate between pest types based on detected capacitance changes.

The present subject matter addresses a significant design flaw identified in existing pest detection devices, particularly those used in environments with high levels of water exposure, such as during cleaning or washdown activities. The primary issue leading to false alerts in these devices is water ingress through front-facing drainage holes, which causes transient capacitive events over the sensor. This results in a high rate of false positives, leading to unnecessary site visits and operational inefficiencies. The present system proposes the incorporation of a water spray barrier to block water ingress while maintaining the device's drainage capability, effectively reducing false alerts to near zero.

The development of this subject matter involved a series of lab evaluations and prototype testing. Some embodiments use stainless steel sheet metal affixed with hot glue to cover the drainage openings, ensuring water could still drain while preventing ingress. Other embodiments use injection-molded plastic barriers that snap into place, providing a more robust and cost-effective solution. The strategic importance of the present subject matter lies in its ability to enhance the reliability of pest detection systems.

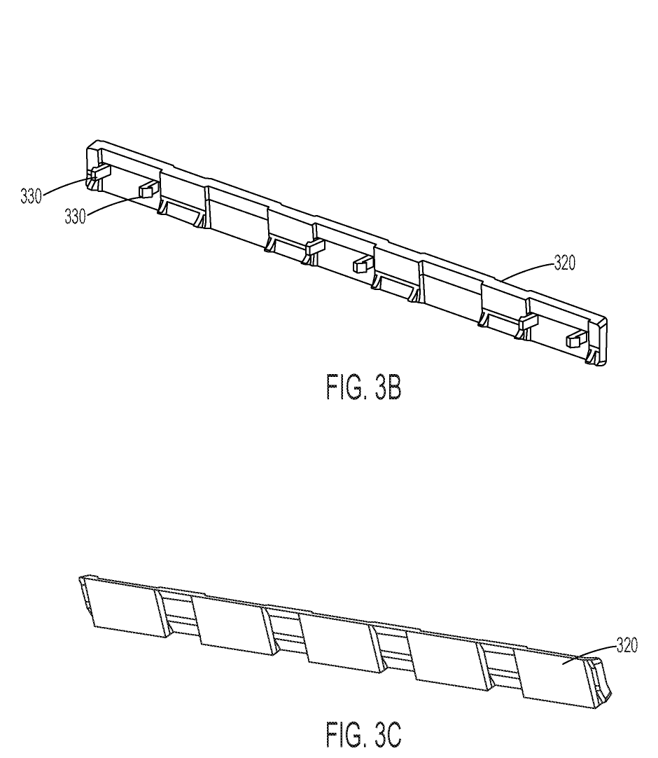

FIG. 3A shows a bottom view of a pest detection and containment device 300 with a snap-in plastic environmental barrier 320 designed for the housing 302. The barrier is affixed to the housing to prevent water ingress while allowing drainage. The environmental barrier 320 may be made of any suitable material, including plastic, deformable rubber, metal, plastic, or other durable materials. FIG. 3B illustrates a rear view of the snap-on environmental barrier 320, highlighting the tabs 330. These tabs are shaped or molded to snap fit securely to the housing of the pest detection device, ensuring a stable attachment that can withstand environmental conditions. In some examples, the tabs 330 are configured to snap fit to the drainage openings of the pest detection and containment device. FIG. 3C provides a front view of the snap-on environmental barrier 320. This view emphasizes the barrier's design for the housing, which selectively covers portions of the drainage openings to prevent water ingress while allowing for effective drainage.

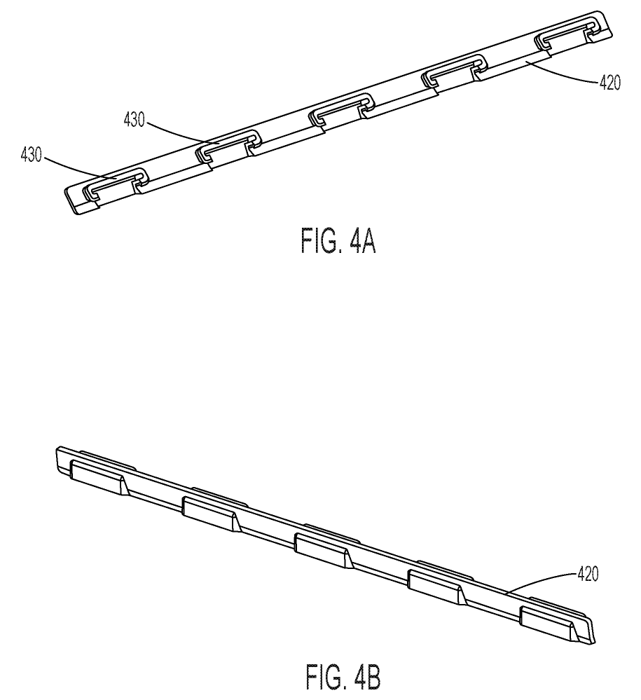

FIG. 4A depicts a rear view of another embodiment of a snap-on environmental barrier 420, featuring tabs 430. Similar to the previous design, these tabs are shaped or molded to snap fit to the housing of the pest detection device, providing a secure and reliable attachment. In some examples, the tabs 430 are configured to snap fit to the drainage openings of the pest detection and containment device. FIG. 4B shows a front view of the snap-on environmental barrier 420. This figure highlights the barrier's configuration for the housing, which is designed to cover peripheral portions of the drainage openings, thereby preventing water ingress while maintaining drainage capabilities. The environmental barrier 420, like the previous designs, may be constructed from any suitable material, including plastic, deformable rubber, metal, or other durable options.

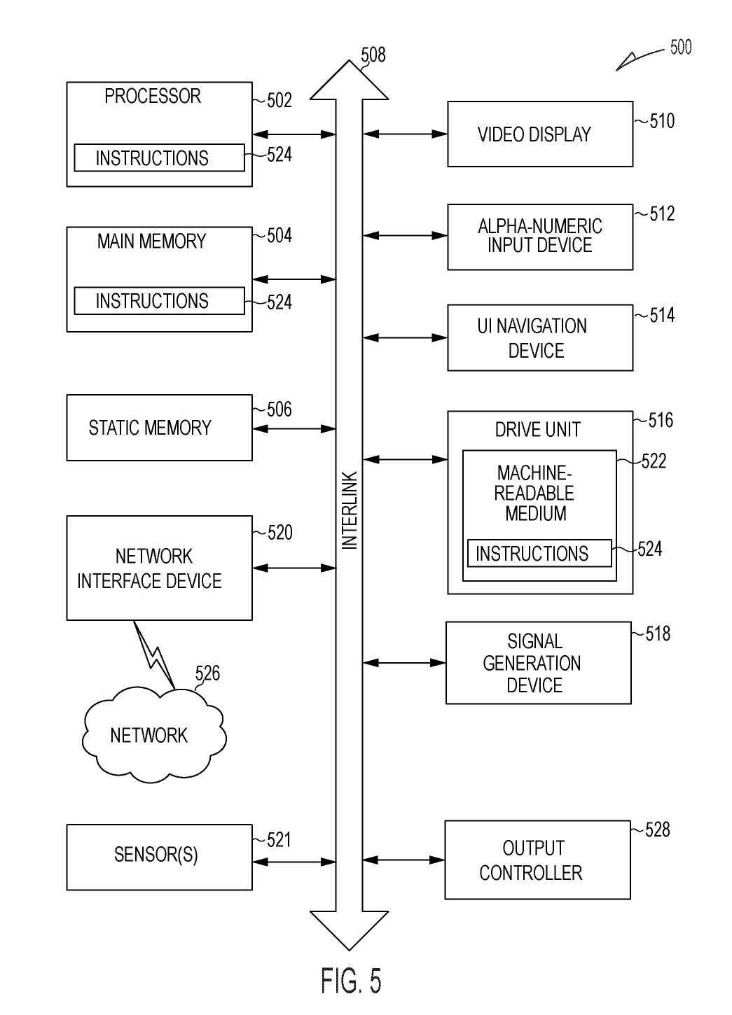

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a controller, a microcontroller, a microprocessor, a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term "machine readable medium" may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, Zigbee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-540/ISO/IEC 18092 and/or ECMA-552/ISO/IEC 21481 to communicate with other devices. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a pest detection device, including: a housing including a plurality of drainage openings and at least partially defining an internal chamber; a capacitive sensor disposed within the internal chamber and configured to detect a presence of one or more pests in proximity to the plurality of drainage openings; and an environmental barrier connected to a surface of the housing to selectively cover portions of the plurality of drainage openings such that water spray directed toward the housing is prevented from entering the internal chamber while permitting water to drain therethrough.

Example 2 is the pest detection device of Example 1, wherein the capacitive sensor is a multi-layer sensor configured to improve sensitivity to small pests.

Example 3 is the pest detection device of Example 2, wherein the capacitive sensor includes a calibration feature to adjust for environmental changes.

Example 4 is the pest detection device of Example 1, further including an environmental barrier made out of rubber.

Example 5 is the pest detection device of Example 1, further including an environmental barrier made out of metal.

Example 6 is the pest detection device of Example 1, further including an environmental barrier made out of plastic.

Example 7 is the pest detection device of Example 1, further including a controller configured to process signals detected by the capacitive sensor and to differentiate between pest types based on detected capacitance changes.

Example 8 is the pest detection device of Example 7, wherein the controller communicates with a user interface for status monitoring.

Example 9 is a method for making a pest detection device with an environmental barrier, including: providing a housing with a surface having a plurality of drainage openings and defining an internal chamber; installing a capacitive sensor within the internal chamber, the sensor configured to detect a presence of one or more pests in proximity to the plurality of drainage openings; and affixing an environmental barrier to the surface of the housing, the barrier configured to selectively cover portions of the plurality of drainage openings.

Example 10 is the method of Example 9, wherein the capacitive sensor includes a multi-layer sensor to enhance sensitivity to small pests.

Example 11 is the method of Example 9, further including calibrating the capacitive sensor to adjust for environmental changes.

Example 12 is the method of Example 11, wherein the calibrating is performed on a time basis.

Example 13 is the method of Example 11, wherein the calibrating is performed by an instruction.

Example 14 is the method of Example 9, further including configuring a controller to process signals detected by the capacitive sensor and to differentiate between pest types based on detected capacitance changes.

Example 15 is a pest detection system, including: a housing having a surface with a plurality of drainage openings and defining an internal chamber; a capacitive sensor disposed within the internal chamber and configured to detect a presence of one or more pests in proximity to the plurality of drainage openings; an environmental barrier affixed to the surface of the housing, the barrier configured to selectively cover peripherally located portions of the plurality of drainage openings to prevent water spray from entering the internal chamber while allowing water to drain therethrough; and a controller configured to process signals detected by the capacitive sensor and to communicate pest detection data to an external device.

Example 16 is the pest detection system of Example 15, wherein the capacitive sensor includes a multi-layer sensor configured to enhance sensitivity to small pests.

Example 17 is the pest detection system of Example 15, further including a calibration feature integrated into the capacitive sensor to adjust for environmental changes.

Example 18 is the pest detection system of Example 17, further including a timer, wherein the calibration feature is performed using the timer.

Example 19 is the pest detection system of Example 17, wherein the calibration feature is performed after receipt of a calibration instruction.

Example 20 is the pest detection system of Example 15, wherein the controller includes wireless communication capability to transmit pest detection data to an external device, such as a computer, smartphone, or tablet.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A pest detection device, comprising:
a housing including a plurality of drainage openings and at least partially defining an internal chamber;
a capacitive sensor disposed within the internal chamber and configured to detect a presence of one or more pests in proximity to the plurality of drainage openings; and
an environmental barrier connected to a surface of the housing to selectively cover portions of the plurality of drainage openings such that water spray directed toward the housing is prevented from entering the internal chamber while permitting water to drain therethrough.

2. The pest detection device of claim 1, wherein the capacitive sensor is a multi-layer sensor configured to improve sensitivity to small pests.

3. The pest detection device of claim 2, wherein the capacitive sensor includes a calibration feature to adjust for environmental changes.

4. The pest detection device of claim 1, further comprising an environmental barrier made out of rubber.

5. The pest detection device of claim 1, further comprising an environmental barrier made out of metal.

6. The pest detection device of claim 1, further comprising an environmental barrier made out of plastic.

7. The pest detection device of claim 1, further comprising a controller configured to process signals detected by the capacitive sensor and to differentiate between pest types based on detected capacitance changes.

8. The pest detection device of claim 7, wherein the controller communicates with a user interface for status monitoring.

9. A method for making a pest detection device with an environmental barrier, comprising:
providing a housing with a surface having a plurality of drainage openings and defining an internal chamber;
installing a capacitive sensor within the internal chamber, the sensor configured to detect a presence of one or more pests in proximity to the plurality of drainage openings; and
affixing an environmental barrier to the surface of the housing, the barrier configured to selectively cover portions of the plurality of drainage openings.

10. The method of claim 9, wherein the capacitive sensor includes a multi-layer sensor to enhance sensitivity to small pests.

11. The method of claim 9, further comprising calibrating the capacitive sensor to adjust for environmental changes.

12. The method of claim 11, wherein the calibrating is performed on a time basis.

13. The method of claim 11, wherein the calibrating is performed by an instruction.

14. The method of claim 9, further comprising configuring a controller to process signals detected by the capacitive sensor and to differentiate between pest types based on detected capacitance changes.

15. A pest detection system, comprising:
a housing having a surface with a plurality of drainage openings and defining an internal chamber;
a capacitive sensor disposed within the internal chamber and configured to detect a presence of one or more pests in proximity to the plurality of drainage openings;
an environmental barrier affixed to the surface of the housing, the barrier configured to selectively cover peripherally located portions of the plurality of drainage openings to prevent water spray from entering the internal chamber while allowing water to drain therethrough; and
a controller configured to process signals detected by the capacitive sensor and to communicate pest detection data to an external device.

16. The pest detection system of claim 15, wherein the capacitive sensor includes a multi-layer sensor configured to enhance sensitivity to small pests.

17. The pest detection system of claim 15, further comprising a calibration feature integrated into the capacitive sensor to adjust for environmental changes.

18. The pest detection system of claim 17, further comprising a timer, wherein the calibration feature is performed using the timer.

19. The pest detection system of claim 17, wherein the calibration feature is performed after receipt of a calibration instruction.

20. The pest detection system of claim 15, wherein the controller includes wireless communication capability to transmit pest detection data to an external device, such as a computer, smartphone, or tablet.
